(19) United States
(12) Patent Application Publication
(10) Pub. No.: US 2018/0337989 A1
(43) Pub. Date: Nov. 22, 2018

(54) SYSTEM AND METHOD FOR SYNCHRONIZING DATA BETWEEN COMPUTER DEVICES

(71) Applicant: MZ IP Holdings, LLC, Palo Alto, CA (US)

(72) Inventors: Garth Gillespie, Palo Alto, CA (US); Nathan Spencer, Redwood City, CA (US); John O'Connor, Sunnyvale, CA (US); Yan Zhang, Mountain View, CA (US)

(21) Appl. No.: 15/967,984

(22) Filed: May 1, 2018

Related U.S. Application Data
(60) Provisional application No. 62/507,320, filed on May 17, 2017.

(51) Int. Cl. H04L 29/08; A63F 13/335

(52) U.S. Cl. CPC H04L 67/1095; A63F 13/335; H04L 67/34

(57) ABSTRACT

Implementations of the present disclosure are directed to a method, a system, and an article for synchronizing data between computer devices. An example computer-implemented method can include: providing a plurality of models representing one or more elements of a software application; determining that a model from the plurality of models is out-of-date; updating a first copy of the model stored on a server system; determining a set of modifications for achieving the update; sending the set of modifications to at least one client device that stores a second copy of the model; and updating the stored second copy of the model according to the set of modifications.

### CROSS-REFERENCE TO RELATED APPLICATIONS

This application claims the benefit of U.S. Provisional Patent Application No. 62/507,320, filed May 17, 2017, the entire contents of which are incorporated by reference herein.

### BACKGROUND

The present disclosure relates to data synchronization and, in particular, to systems and methods for synchronizing data between computer devices for a software application, for example, for a multiplayer online game.

In general, a multiplayer online game can be played by hundreds of thousands or even millions of players who use client devices to interact with a virtual environment for the online game. The players are typically working to accomplish tasks, acquire assets, or achieve a certain score in the online game. Some games require or encourage players to form groups or teams that can play against other players or groups of players.

The state of a multiplayer online game and/or its virtual environment can change over time as players interact with the game and various events unfold. It can be desirable for the state of the game to be consistent among client devices and/or a server computer that manages the game.

### SUMMARY

In general, the subject matter of this disclosure relates to systems and methods for managing data stored on client devices and a server system for a software application (e.g., for a multiplayer online game). In a typical example, the software application utilizes a plurality of models (e.g., collections of data) that define a state of a plurality of elements for the software application. When an event occurs that causes one of the elements to change, a first copy of the corresponding model stored on the server system can be updated. A set of modifications required to achieve the update can be bundled and sent to the client devices. A second copy of the model on the client devices can then be updated using the set of modifications. In this way, the first and second copies of the model on the server system and the client devices, respectively, can be synchronized. Each time the first copy of the model is updated on the server system, a bundled set of modifications can be sent to the client devices, so that an identical second copy can be generated.

Advantageously, the approach described herein is able to achieve a real-time synchronization between a first copy of a model on a server system and a second copy of the model on one or more client devices. This can allow the client devices to use local (second) copies of a model, without having to request a model update or verify the model status when the model is used. In the context of a multiplayer online game, it can be important for all client devices to use current and accurate versions of each model, so that any action taken by a user is permissible and/or consistent with a current state of the game, as managed by the server system.

Further, by preparing and sending the bundled set of modifications, the systems and methods described herein can avoid having to send an entire updated model to the client devices each time the model is updated on the server system. Given that the set of modifications is generally much smaller than the model itself (e.g., by a factor 2, 10, 100, or more), sending the set of modifications rather than the entire updated model can achieve a significant reduction in network traffic, particularly when the number of client devices that store the model is in the thousands or millions. The approach can also improve efficiency by informing the client devices when changes occur and allowing the client devices to continue using local copies of other, unchanged models. By pushing changes to client devices in this manner, the server and the client devices can avoid unnecessary communications and data transmissions.

In one aspect, the subject matter described in this specification relates to a computer-implemented method. The method includes: providing a plurality of models representing one or more elements of a software application; determining that a model from the plurality of models is out-of-date; updating a first copy of the model stored on a server system; determining a set of modifications for achieving the update; sending the set of modifications to at least one client device that stores a second copy of the model; and updating the stored second copy of the model according to the set of modifications.

In certain examples, each model can include a collection of data defining a state of at least one of the elements. The software application can include or provide a multiplayer online game. The one or more elements can be or include at least one of a virtual asset, a virtual object, a virtual character, a virtual environment, a user, a group of users, and any combination thereof. Providing the plurality of models can include storing first copies of the models on the server system and second copies of the models on a plurality of client devices including the at least one client device.

In some implementations, sending the set of modifications can include determining that the at least one client device, out of the plurality of client devices, is assigned to the model. Updating the stored second copy can include synchronizing the first and second copies of the model to be identical. The model can be out-of-date due to an event initiated by the server system and/or a client device. The set of modifications can be configured to implement all model updates precipitated by the event. The method can include: determining that a client device has been disconnected from the server system for longer than a threshold period of time; and updating all models stored on the client device to be identical to corresponding models stored on the server system.

In another aspect, the subject matter described in this specification relates to a system having one or more computer processors programmed to perform operations including: providing a plurality of models representing one or more elements of a software application; determining that a model from the plurality of models is out-of-date; updating a first copy of the model stored on a server system; determining a set of modifications for achieving the update; sending the set of modifications to at least one client device that stores a second copy of the model; and updating the stored second copy of the model according to the set of modifications.

In certain examples, each model can include a collection of data defining a state of at least one of the elements. The software application can include or provide a multiplayer online game. The one or more elements can be or include at least one of a virtual asset, a virtual object, a virtual character, a virtual environment, a user, a group of users, and any combination thereof. Providing the plurality of models can include storing first copies of the models on the server system and second copies of the models on a plurality of client devices including the at least one client device.

In some implementations, sending the set of modifications can include determining that the at least one client device, out of the plurality of client devices, is assigned to the model. Updating the stored second copy can include synchronizing the first and second copies of the model to be identical. The model can be out-of-date due to an event initiated by the server system and/or a client device. The set of modifications can be configured to implement all model updates precipitated by the event. The operations can include: determining that a client device has been disconnected from the server system for longer than a threshold period of time; and updating all models stored on the client device to be identical to corresponding models stored on the server system.

In another aspect, the subject matter described in this specification relates to an article. The article includes a non-transitory computer-readable medium having instructions stored thereon that, when executed by one or more computer processors, cause the computer processors to perform operations including: providing a plurality of models representing one or more elements of a software application; determining that a model from the plurality of models is out-of-date; updating a first copy of the model stored on a server system; determining a set of modifications for achieving the update; sending the set of modifications to at least one client device that stores a second copy of the model; and updating the stored second copy of the model according to the set of modifications.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for managing a state of a software application.

FIG. 2 is a schematic diagram of a mapping between a plurality of users and a plurality of models for a software application.

FIG. 3 is a schematic data flow diagram for an example method of synchronizing data between one or more client devices and a server system.

FIG. 4 is a flowchart of an example method of managing a state of a software application.

### DETAILED DESCRIPTION

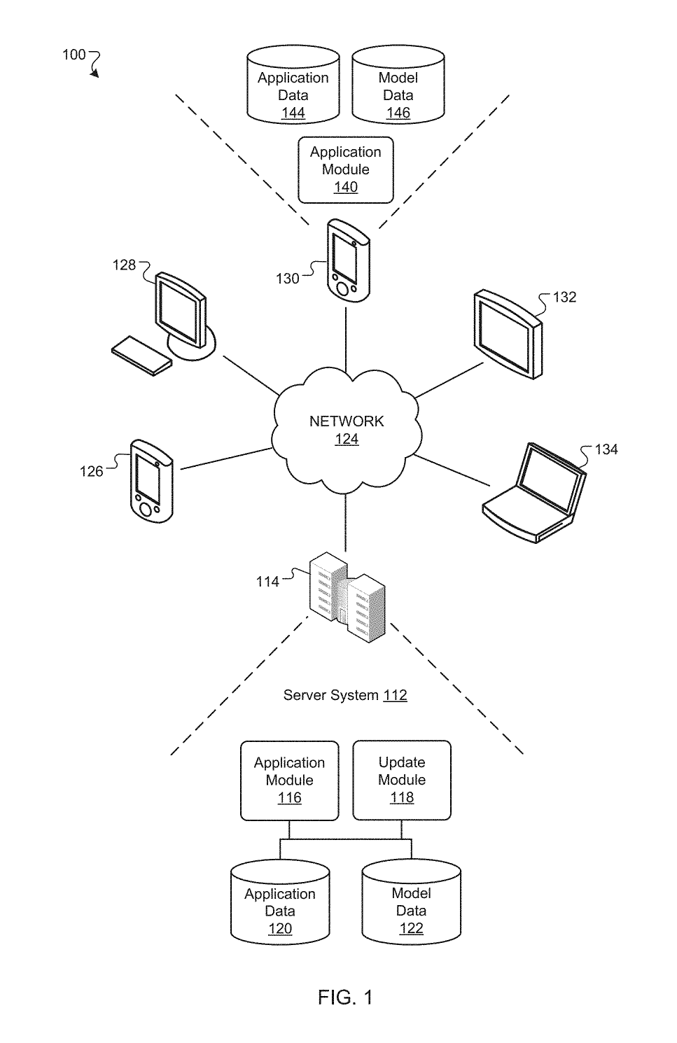

FIG. 1 illustrates an example system 100 for managing a state of a software application, such as a multiplayer online game. A server system 112 provides functionality for updating models that represent one or more elements of the software application. The server system 112 includes software components and databases that can be deployed at one or more data centers 114 in one or more geographic locations, for example. In certain instances, the server system 112 is, includes, or utilizes a content delivery network (CDN). The server system 112 software components can include an application module 116 and an update module 118. The server system 112 can include subcomponents that can execute on the same or on different individual data processing apparatus. The server system 112 databases can include an application data 120 database and a model data 122 database. The databases can reside in one or more physical storage systems. The software components and data will be further described below.

An application, such as, for example, a web-based or other software application can be provided as an end-user application to allow users to interact with the server system 112. The software application or components thereof can be accessed through a network 124 (e.g., the Internet) by users of client devices, such as a smart phone 126, a personal computer 128, a smart phone 130, a tablet computer 132, and a laptop computer 134. Other client devices are possible.

Each client device in the system 100 can utilize or include software components and databases for the software application. The software components on the client devices can include, for example, an application module 140 configured to implement the software application. The databases on the client devices can include an application data 144 database and a model data 146 database. The application data 144 database can store data for the software application and exchange the data with the application module 140. The data stored on the application data 144 database can include, for example, user data, image data, video data, and any other data used or generated by the application module 140. The model data 146 database can store information or data for a plurality of models representing one or more elements of the software application. Such information can include, for example, data describing a current state of a user, a group of users, a virtual item, or a virtual environment associated with the software application. The information in the model data 146 database can be maintained and updated by the server system 112 (e.g., using the update module 118) as described herein. While the application module 140, the application data 144 database, and the model data 146 database are depicted as being associated with the smart phone 130, it is understood that other client devices (e.g., the smart phone 126, the personal computer 128, the tablet computer 132, and/or the laptop computer 134) can include the application module 140, the application data 144 database, the model data 146 database, and any portions thereof.

Still referring to FIG. 1, the application module 116 can include software components that support the software application by, for example, performing calculations, implementing software updates, exchanging information or data with the update module 118 and/or the application module 140, assisting with the initialization of the software application, and/or monitoring an overall status of the software application. The update module 118 can include software components that maintain or update models (e.g., collections of data) representing one or more elements of the software application. The update module 118 can update copies of the models stored on the server system 112 (e.g., in the model data 122 database) and on the client devices (e.g., in the model data 146 database). The application data 120 database can store and provide data for the software application. The data can include, for example, user data, image data, video data, animation data, and/or any other data that can be used by the server system 112 and/or client devices to run the software application. In certain instances, for example, the application module 116 can retrieve data (e.g., video data or image data) from the application data 120 database and send the data to client devices.

The software application implemented on the client devices 126, 128, 130, 132, and 134 can relate to and/or provide a wide variety of functions and information, including, for example, entertainment (e.g., a game, music, videos, etc.), business (e.g., word processing, accounting, spreadsheets, etc.), news, weather, finance, sports, etc. In certain instances, the software application provides a multiplayer online game that can be or include, for example, an adventure game, a virtual playing card game, a virtual board game, a vehicle operating game, or other type of multiplayer game. The game can include a virtual environment in which the users (also referred to as players) or the users' avatars can have various capabilities. The capabilities can be or include, for example, moving an avatar or a virtual item or object to a different geographical location, interacting with characters or other users, attacking other users, deploying troops, defending against an attack from other users, deploying defenses, building or modifying a virtual item or object (e.g., a virtual building or other structure), developing a new skill, operating a vehicle, acquiring a virtual item (e.g., a weapon), using or interacting with a virtual item (e.g., a playing card or a weapon), and performing supernatural tasks (e.g., casting a spell). Other user capabilities are possible. While some of the discussion herein indicates that the software application relates to a computer game (e.g., a multiplayer online game), it is understood that the systems and methods described herein are applicable to other software applications that do not relate to computer games. In general, the systems and methods described herein can be used to synchronize data between a server computer and one or more client devices for any type of software application.

In various examples, the software application can include or utilize one or more models that define a current state of the software application. Each model can be or include a collection of data representing a current state of an element or a collection of elements for the software application. An element can be or relate to, for example, a user, a group of users, an object, a feature, a graphical user interface, or some other component of the software application. In the context of a multiplayer online game, for example, a model can define a current state of a user, an affiliation of users, a virtual item (e.g., a virtual building or weapon), a virtual character (e.g., a virtual person or animal), a virtual asset (e.g., virtual currency), and/or a virtual environment or any component thereof. The current state can be or include a present condition (e.g., a health), value (e.g., in virtual currency), level, collection of assets (e.g., a user's belongings), etc. Other types of models and/or elements can be used.

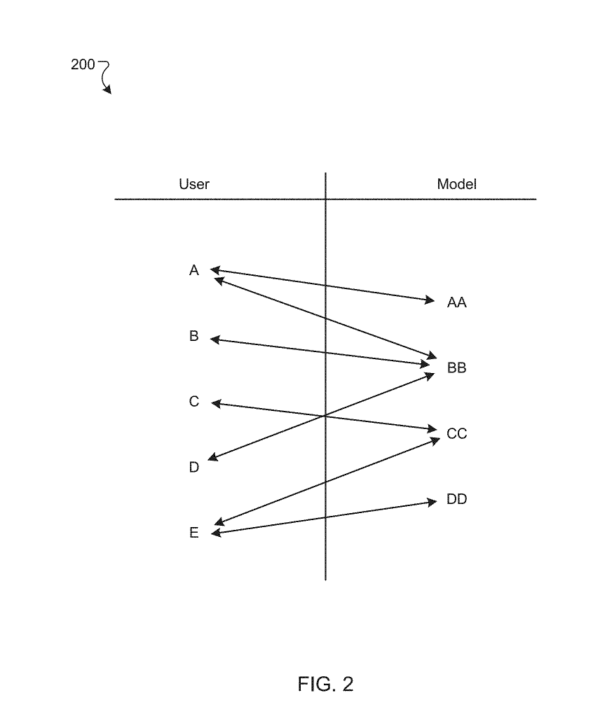

In general, each user of the software application can be assigned to one or more models that define elements associated with or used by the user. Referring to FIG. 2, for example, a mapping 200 between users and models can indicate that there are five users (A through E) who are assigned to four models (AA through DD). User A in this example is assigned to models AA and BB, and user E is assigned to models CC and DD. Other assignments for the users to the models are possible. In general, when one of the models is determined to be out-of-date (e.g., the model is no longer current or is soon to be outdated), the update module 118 can determine which users are assigned to the model and can update the model on the users' client devices (e.g., as stored in the model data 146 database) and/or on the server system 112 (e.g., in the model data 122 database), as described herein. For example, if model BB is determined to be out-of-date, the update module 118 can update the model on the server system 112 and on client devices for users A, B, and D, who are assigned to model BB. In various examples, model assignments can be stored in one or more databases (e.g., the model data 146 database and/or the model data 122 database), which can be accessed by the update module 118. The client devices for users assigned to a model can be referred to as client stakeholders for the model. In a typical implementation, each client stakeholder for a model can store a copy of the model (e.g., in the model data 146 database).

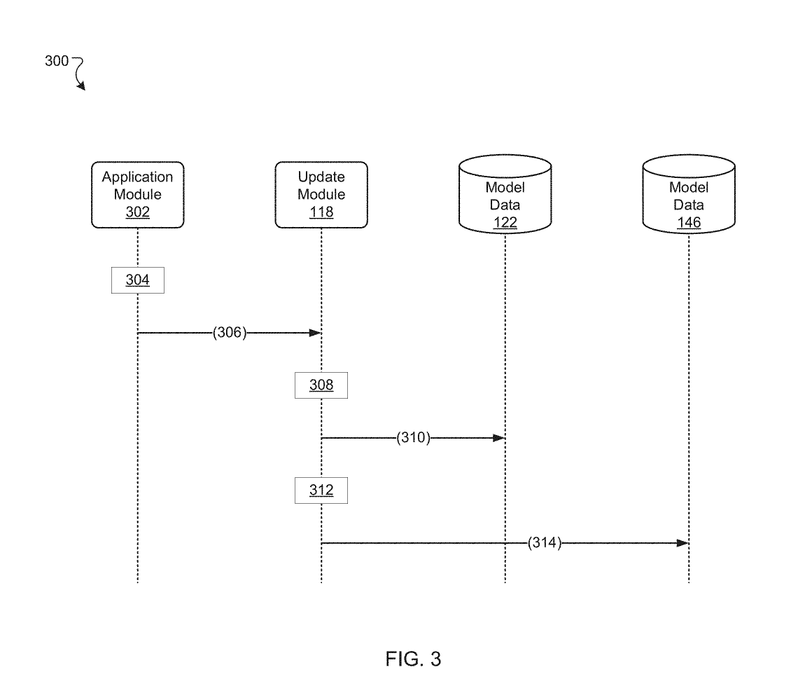

FIG. 3 includes a data flow diagram for an example method 300 of synchronizing model data between one or more client devices and a server system (e.g., the server system 112) for a multiplayer online game or other application. The method 300 can utilize an application module 302 (e.g., the application module 116 and/or the application module 140), the update module 118, the model data 122 database, and the model data 146 database. The method 300 can begin when the application module 302 determines (step 304) that a model for the game is or will be out-of-date, for example, due to one or more events initiated by the server system 112 and/or by users of the client devices. Events initiated by the server system 112 can include, for example, a change to a virtual environment, a new virtual item, a new arrangement of virtual items, a new contest between users, and/or a new rule. Such server-initiated events can be referred to in some instances as real-time events. Events initiated by a user can include, for example, a request to move, use, acquire, abandon, create, or destroy an item or other asset, a request to interact with another user, and/or a request to join, leave, or modify a group or alliance of users. Other types of events are possible.

Next, the application module 302 can instruct (step 306) the update module 118 to update the model based on the one or more events. The update module 118 can determine (step 308) a set of modifications that can be used to achieve a full update of the model. In a preferred example, the set of modifications can be or include all model changes that result from or are precipitated by the one or more game events. In other words, the set of modifications can be used to fully resolve any changes to the model that occur due to the one or more game events. The update module 118 can use the set of modifications to update (step 310) a first copy of the model stored on the server system 112 (e.g., in the model data 122 database). The update module 118 can also determine (step 312) which client devices are assigned to the model, for example, based on a mapping (e.g., the mapping 200) between users and models. The update module 118 can then send the set of modifications (e.g., as a bundled package) to the assigned client devices and/or can otherwise use the set of modifications to update (step 314) a second copy of the model stored on the assigned client devices (e.g., in the model data 146 database). Once the second copy has been updated, the first and second copies of the model can be identical.

In general, the method 300 can be used to update models on the server system 112 and on client devices when one or more events are initiated by the server system 112 and/or the client devices. Such events can result in one or more models being out-of-date or otherwise requiring modification. In some instances, a client device can submit a request to change a model and, before updating the model, the update module 118 can confirm that the client device has permission to make the change. This can involve, for example, confirming that the client device (or associated user) is assigned to the model or otherwise uses or can access the model. Once the permission is confirmed, the update module 118 can update the first copy of the model on the server system 112 and the second copy of the model on any assigned client devices (e.g., the client stakeholders).

In general, when a model on the server system 112 has been changed or updated, all changes made to implement the update (e.g., the set of modifications) can be bundled and pushed to the assigned client devices. Such changes are preferably sent to or implemented on the assigned client devices after the model has been updated fully on the server system 112. The changes can be sent, for example, once the update module 118 confirms that all changes (e.g., due to an event) to the model on the server system 112 have been made or fully resolved. The update module 118 can be explicitly informed that all changes are fully resolved or, in some instances, the update module 118 can automatically determine that all changes are fully resolved once application logic for an event has been processed. For example, the application logic can indicate that an event will require changes A, B, and C for a model. Once the event occurs and changes A, B, and C for the model have been made or fully resolved on the server system 112, the model on the client devices can also be updated with changes A, B, and C, so that the server system 112 and the client devices can have identical copies of the model. For other models that have not been changed, there is generally no need for the update module 118 to send any modifications to the client devices. This can allow the client devices to proceed under an assumption that the local (second) copies of such models are consistent with the server system 112 (first) copies.

In various implementations, model updates can be performed when a connection between a client device and the server system 112 has been lost or disrupted. For example, when a client device reestablishes a connection with the server system 112 after having been disconnected for more than a threshold period of time (e.g., 1 second, 5 seconds, 10 seconds, or 60 seconds), a portion or all of the models on the client device can be synchronized with the corresponding models on the server system 112. This can involve sending the complete models from the server system 112 to the respective assigned client devices. This can ensure that the client devices have the latest versions of the models whenever connections are first established or reestablished. In some instances, the threshold period of time can be exceeded when a user closes the software application or moves the software application to a background, for example, to use other software applications on the user's client device.

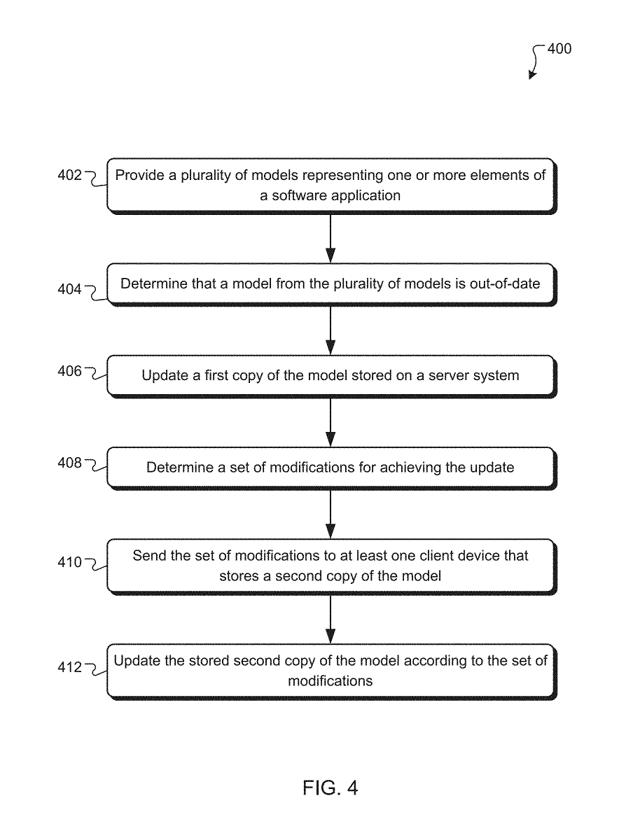

FIG. 4 illustrates an example computer-implemented method 400 of managing a state of a software application (e.g., for a multiplayer online game). A plurality of models are provided (step 402) that represent one or more elements of the software application. A model from the plurality of models is determined (step 404) to be out-of-date. A first copy of the model stored on a server system (e.g., the server system 112) is updated (step 406). A set of modifications for achieving the update is determined (step 408). The set of modifications is sent (step 410) to at least one client device that stores a second copy of the model. The stored second copy of the model is updated (step 412) according to the set of modifications.

Advantageously, the systems and methods described herein can allow the models for a multiplayer online game or other software application to be synchronized and kept up-to-date, preferably in real-time, on the server system 112 and a plurality of client devices. This can allow the client devices to act or make decisions based on local (second) copies of the models, without having to read model data from the server system 112 and/or without having to verify that the local copies are correct.

The approach described herein has several advantages for computer networking and processing. For example, to keep models up-to-date on the client devices, any changes to the models can be pushed to the client devices, and there is generally no need for any communications to occur between the server system 112 and the client devices for models that are current. Additionally, the set of modifications used to update a model on the client devices is generally smaller than the entire model itself. By communicating the set of modifications, and not the entire model, data transmissions can be significantly reduced, particularly when there are thousands or millions of assigned client devices. Further, when a model is out-of-date (e.g., due to an event in an online game), the set of modifications can be used to update the model all at once, using a single data package. There is generally no need to send multiple data packages or make changes at different times, to achieve a full update (e.g., for the event).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A computer-implemented method, comprising:
providing a plurality of models representing one or more elements of a software application;
determining that a model from the plurality of models is out-of-date;
updating a first copy of the model stored on a server system;
determining a set of modifications for achieving the update;
sending the set of modifications to at least one client device that stores a second copy of the model; and
updating the stored second copy of the model according to the set of modifications.

2. The method of claim 1, wherein each model comprises a collection of data defining a state of at least one of the elements.

3. The method of claim 1, wherein the software application comprises a multiplayer online game.

4. The method of claim 1, wherein the one or more elements comprise at least one of a virtual asset, a virtual object, a virtual character, a virtual environment, a user, a group of users, and any combination thereof.

5. The method of claim 1, wherein providing the plurality of models comprises:
storing first copies of the models on the server system and second copies of the models on a plurality of client devices comprising the at least one client device.

6. The method of claim 5, wherein sending the set of modifications comprises:
determining that the at least one client device, out of the plurality of client devices, is assigned to the model.

7. The method of claim 1, wherein updating the stored second copy comprises:
synchronizing the first and second copies of the model to be identical.

8. The method of claim 1, wherein the model is out-of-date due to an event initiated by at least one of the server system and a client device.

9. The method of claim 8, wherein the set of modifications is configured to implement all model updates precipitated by the event.

10. The method of claim 1, further comprising:
determining that a client device has been disconnected from the server system for longer than a threshold period of time; and
updating all models stored on the client device to be identical to corresponding models stored on the server system.

11. A system, comprising:
one or more computer processors programmed to perform operations comprising:
providing a plurality of models representing one or more elements of a software application;
determining that a model from the plurality of models is out-of-date;
updating a first copy of the model stored on a server system;
determining a set of modifications for achieving the update;
sending the set of modifications to at least one client device that stores a second copy of the model; and
updating the stored second copy of the model according to the set of modifications.

12. The system of claim 11, wherein each model comprises a collection of data defining a state of at least one of the elements.

13. The system of claim 11, wherein the software application comprises a multiplayer online game.

14. The system of claim 11, wherein providing the plurality of models comprises:
storing first copies of the models on the server system and second copies of the models on a plurality of client devices comprising the at least one client device.

15. The system of claim 14, wherein sending the set of modifications comprises:
determining that the at least one client device, out of the plurality of client devices, is assigned to the model.

16. The system of claim 11, wherein updating the stored second copy comprises:
synchronizing the first and second copies of the model to be identical.

17. The system of claim 11, wherein the model is out-of-date due to an event initiated by at least one of the server system and a client device.

18. The system of claim 17, wherein the set of modifications is configured to implement all model updates precipitated by the event.

19. The system of claim 11, the operations further comprising:
determining that a client device has been disconnected from the server system for longer than a threshold period of time; and
updating all models stored on the client device to be identical to corresponding models stored on the server system.

20. An article, comprising:
a non-transitory computer-readable medium having instructions stored thereon that, when executed by one or more computer processors, cause the computer processors to perform operations comprising:
providing a plurality of models representing one or more elements of a software application;
determining that a model from the plurality of models is out-of-date;
updating a first copy of the model stored on a server system;
determining a set of modifications for achieving the update;
sending the set of modifications to at least one client device that stores a second copy of the model; and
updating the stored second copy of the model according to the set of modifications.
